(19) United States
(12) Patent Application Publication
(10) Pub. No.: US 2023/0053646 A1
(43) Pub. Date: Feb. 23, 2023

(54) PHOTODEDGRADANT FOR CARBAMAZEPINE, METHOD AND APPARATUS FOR DEGRADING CARBAMAZEPINE

(71) Applicant: Jilin Jianzhu University, Changchun (CN)

(72) Inventors: Yingzi LIN, Changchun (CN); Hao YANG, Changchun (CN); Siwen LI, Changchun (CN); Gen LIU, Changchun (CN); Hao LI, Changchun (CN); Mingliang ZHOU, Changchun (CN); Yuhang WEI, Changchun (CN)

(21) Appl. No.: 17/453,664

(22) Filed: Nov. 5, 2021

(30) Foreign Application Priority Data
Aug. 3, 2021 (CN) 202110886543.8

(51) Int. Cl. C02F 1/72; C02F 1/32

(52) U.S. Cl. CPC C02F 1/725; C02F 1/325; C02F 2101/38

(57) ABSTRACT

The disclosure provides a photodegradant for carbamazepine, a method and an apparatus for degrading carbamazepine, and relates to the technical filed of degradation of organic pollutants. The photodegradant provided by the disclosure includes a composite solution of a persulfate and a sulfite. In the disclosure, ultraviolet (UV), the persulfate (PS) and the sulfite (S(IV)) are combined to degrade carbamazepine, during which hydrogen sulfate (HSO₃⁻) generated by the hydrolysis of sulfite in water participates in the reaction to produce a large amount of SO₄^{⋅-} and HO⋅, thus improving the degradation rate and degradation efficiency of carbamazepine. The composite advanced oxidation system, i.e., the ultraviolet/persulfate/sulfite (UV/PS/S(IV)) system, provided by the disclosure has stronger oxidizability than the ultraviolet/persulfate (UV/PS) system and the ultraviolet/sulfite (UV/S(IV)) system, and results in high degradation rate and high degradation efficiency of carbamazepine.

### CROSS REFERENCE TO RELATED APPLICATION

This application claims the benefit and priority of Chinese Patent Application No. 202110886543.8 filed on Aug. 3, 2021, the disclosure of which is incorporated by reference herein in its entirety as part of the present application.

### TECHNICAL FIELD

The present disclosure relates to the technical filed of degradation of organic pollutants, and specifically relates to a photodegradant for carbamazepine, a method and an apparatus for degrading carbamazepine.

### BACKGROUND ART

Carbamazepine (CBZ), as a common antiepileptic drug, is widely used in clinical treatment. Carbamazepine has strong durability and stability in water, and is a very representative example of refractory pharmaceuticals and personal care products (PPCPs) pollutants. It is difficult to be removed either in the natural circulation process of water or in the conventional water treatment process. Therefore, it is urgent to develop an effective method to solve the problem of environmental pollution caused by CBZ.

In recent years, the advanced oxidation technology based on sulfate radical (SO₄^{⋅-}) has attracted extensive attention from researchers. The heterogeneous photocatalytic persulfate (PS) system could efficiently produce SO₄^{⋅-} and HO⋅ with strong oxidizing activities at ambient temperature, and has broad application prospects due to its strong oxidizing ability and a wide applicable pH range. In the various advanced oxidation technologies based on sulfate radical, the ultraviolet-activated persulfate method has attracted extensive attention and been researched widely for its advantages such as high generation rate of free radicals, no secondary pollution, low price and good stability of persulfate used therein. However, the conventional ultraviolet/sulfite (UV/S(IV)) system is unsatisfactory for the degradation of carbamazepine.

### SUMMARY

In view of the above, the present disclosure is to provide a photodegradant for carbamazepine, a method and an apparatus for degrading carbamazepine. The photodegradant provided by the present disclosure results in high degradation rate and high degradation efficiency of carbamazepine.

To achieve the above objects, the present disclosure provides the following technical solutions:

The present disclosure provides a photodegradant for carbamazepine, comprising a composite solution of a persulfate and a sulfite.

In some embodiments, a molar ratio of the persulfate to the sulfite in the composite solution is in the range of (1-2):(1-2).

The present disclosure provides a method for degrading carbamazepine by using the photodegradant described in the above technical solution, comprising the following steps:

mixing a carbamazepine solution with the composite solution of the persulfate and the sulfite under ultraviolet irradiation to obtain a mixed solution, and subjecting the mixed solution to a degradation.

In some embodiments, a molar ratio of carbamazepine in the carbamazepine solution to the persulfate to the sulfite is in the range of 1:(15-20):(15-20).

In some embodiments, the carbamazepine solution has a concentration of 10-45 mmol/L.

In some embodiments, the carbamazepine solution has a pH value of 3-11.

In some embodiments, the degradation is conducted for 20-50 min.

The present disclosure provides a photodegradant for carbamazepine, comprising a composite solution of a persulfate and a sulfite. In the present disclosure, ultraviolet (UV), the persulfate (PS) and the sulfite (S(IV)) are combined to degrade carbamazepine, during which hydrogen sulfate (HSU generated by the hydrolysis of sulfite in water participates in the reaction to produce a large amount of SO₄^{⋅-} and HO⋅, thus improving the degradation rate of carbamazepine. As shown in the results of the examples, after degrading for 40 min under the condition of a molar ratio of PS to S(IV) to CBZ of 15:15:1, the removal rate of CBZ reaches 98.3%, and the degradation rate and degradation efficiency of carbamazepine are increased by 10% and 19% respectively compared with the ultraviolet/persulfate system. The above results indicate that the composite advanced oxidation system, i.e., ultraviolet/persulfate/sulfite (UV/PS/S(IV)) system, provided by the present disclosure has stronger oxidizability than the ultraviolet/persulfate (UV/PS) system and the ultraviolet/sulfite (UV/S(IV)) system, and results in high degradation rate and high degradation efficiency of carbamazepine.

The present disclosure provides a method for degrading carbamazepine using the photodegradant described in the above technical solution. In the present disclosure, ultraviolet (UV), the persulfate (PS) and the sulfite (S(IV)) are combined to degrade carbamazepine (CBZ), during which hydrogen sulfate (HSO₃⁻) generated by the hydrolysis of sulfite in water participates in the reaction to produce a large amount of SO₄^{⋅-} and HO⋅, thus improving the degradation rate of carbamazepine. As shown in the results of the examples, after degrading for 40 min under the condition of a molar ratio of PS to S(IV) to CBZ of 15:15: 1, the removal rate of carbamazepine reaches 98.3%, and the degradation rate and degradation efficiency of carbamazepine are respectively increased by 10% and 19% compared with the ultraviolet/persulfate system. The above results indicate that the method provided by the present disclosure results in high degradation rate and high degradation efficiency of carbamazepine. Moreover, the method provided by the present disclosure is suitable for degrading carbamazepine in large scale due to its simple operation, mild degradation conditions, and low degradation cost.

The present disclosure provides an apparatus used for the method, comprising a reaction vessel 3, a quartz sleeve 2 arranged inside the reaction vessel 3, and an ultraviolet light source 1 arranged inside the quartz sleeve 2. The apparatus provided by the present disclosure has a simple structure, and is low in cost, and could realize efficient and deep degradation of carbamazepine.

### BRIEF DESCRIPTION OF THE DRAWINGS

FIG. 1 is a diagram showing an apparatus for degrading carbamazepine according to examples of the present disclosure.

FIG. 2 is a diagram showing a reaction route of free radicals during the degradation process of CBZ.

FIG. 3 is a diagram showing results about an inhibition degree of methanol on active free radicals.

FIG. 4 is a diagram showing results about reaction kinetics fitting of the inhibition degree of methanol on active free radicals.

FIG. 5 is a diagram showing results about the inhibition degree of tert-butanol on active free radicals.

FIG. 6 is a diagram showing results about reaction kinetics fitting of the inhibition degree of tert-butanol on active free radicals.

FIG. 7 is a diagram showing results about the degradations of CBZ in different photodegradation systems.

FIG. 8 is a diagram showing results about reaction kinetics fittings of the degradations of CBZ in different photodegradation systems.

FIG. 9 is a diagram showing results about the degradations of CBZ with different molar ratios of PS to S(IV).

FIG. 10 is a diagram showing results about reaction kinetics fittings of the degradations of CBZ with different molar ratios of PS to S(IV).

FIG. 11 is a diagram showing results about the degradations of CBZ with different initial concentrations of CBZ.

FIG. 12 is a diagram showing results about reaction kinetics fittings of the degradations of CBZ with different initial concentrations of CBZ.

FIG. 13 is a diagram showing results about the degradations of CBZ with different initial concentrations of CO₃²⁻.

FIG. 14 is a diagram showing results about reaction kinetics fittings of the degradations of CBZ with different initial concentrations of CO₃²⁻.

FIG. 15 is a diagram showing results about the degradations of CBZ at different pH values.

FIG. 16 is a diagram showing results about reaction kinetics fittings of the degradations of CBZ at different pH values.

FIG. 17 is a diagram showing changes of the pH value of the solution in a degradation process of CBZ in an UV/PS/S(IV) system of Example 1.

### DETAILED DESCRIPTION OF THE EMBODIMENTS

The present disclosure provides a photodegradant for carbamazepine, including a composite solution of a persulfate and a sulfite.

In the present disclosure, unless otherwise specified, all raw materials are commercially available products well known to those skilled in the art.

In some embodiments, a molar ratio of the persulfate to the sulfite in the composite solution is in the range of (1-2):(1-2). In some embodiments, an ultraviolet light is provided by a low-pressure mercury lamp. In some embodiments, the low-pressure mercury lamp has a power of 6-17 W, and preferably 10-15 W.

The present disclosure provides a method for degrading carbamazepine by using the photodegradant described in the above technical solution, including the following steps:

mixing a carbamazepine solution with the composite solution of the persulfate and the sulfite under ultraviolet irradiation to obtain a mixed solution, and subjecting the mixed solution to a degradation.

In some embodiments, a molar ratio of carbamazepine in the carbamazepine solution to the persulfate to the sulfite is in the range of 1: (15-20):(15-20), and preferably 1:(16-18):(16-18).

In some embodiments, the carbamazepine solution has a concentration of 5-50 mmol/L, preferably 8-45 mmol/L, and more preferably 10.08-42.32 mmol/L.

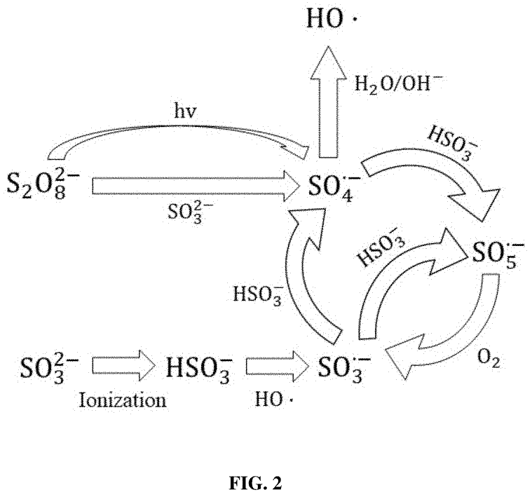

In some embodiments, the carbamazepine solution has a pH value of 3-11, preferably 5-9, and more preferably 7. In some embodiments, the degradation is conducted at a temperature of 18-22° C., and preferably 20° C. In some embodiments, the degradation is conducted for 20-50 min, and preferably 30-40 min. During the degradation process of the present disclosure, hydrogen sulfate (HSO₃⁻) generated by the hydrolysis of sulfite in water participates in the reaction, producing a large amount of SO₄^{⋅-} and HO⋅, which improves the degradation rate of carbamazepine. The specific reaction route of free radicals is shown in FIG. 2. It can be seen from FIG. 2 that part of the reactions in the degradation process are shown as Formulas (1) to (6):

S₂O₈²⁻+hv→2SO₄^{⋅-} Formula (1)

S₂O₈²⁻+SO₃²⁻→SO₄^{⋅-}+SO₄²⁻+SO₃^{⋅-} Formula (2)

SO₃²⁻+HO⋅→HO⁻+SO₃^{⋅-} Formula (3)

SO₄^{⋅-}+HO⁻→HO⋅+SO₄²⁻ Formula (4)

SO₄²⁻+H₂O→HO⋅+HSO₄⁻ Formula (5)

SO₄^{⋅-}+H₂O→HO⋅+HSO₄⁻ Formula (6)

The present disclosure provides an apparatus used for the method described in the above technical solution, including a reaction vessel 3, a quartz sleeve 2 arranged inside the reaction vessel 3, and an ultraviolet light source 1 arranged inside the quartz sleeve 2. In some embodiments, the ultraviolet light source is a low-pressure mercury lamp, and the low-pressure mercury lamp has a power of 6-17 W, and preferably 10-15 W. In some embodiments, the apparatus further includes a thermostat magnetic stirrer 5. In some embodiments, the reaction vessel 3 is mounted on the surface of the thermostat magnetic stirrer 5. In some embodiments, the reaction vessel 3 is provided with a rotor 4.

The technical solutions of the present disclosure will be clearly and completely described below in conjunction with the examples of the present disclosure. Obviously, the described examples are only a part of embodiments of the present disclosure, rather than all the embodiments. Based on the examples of the present disclosure, all other embodiments obtained by those ordinarily skilled in the art without creative work shall fall within the protection scope of the present disclosure.

### EXAMPLE 1

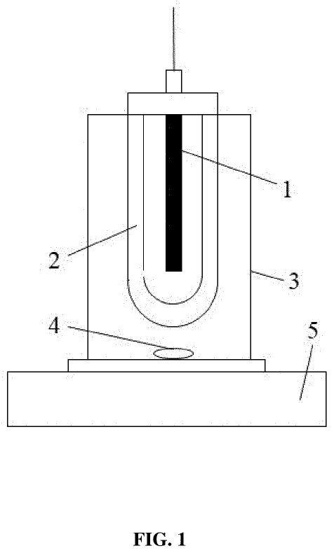

(1) Using an Ultraviolet/Persulfate/Sulfite UV/PS/S(IV) System to Degrade Carbamazepine in an Apparatus Shown in FIG. 1

Under the irradiation of a low-pressure mercury lamp with a power of 10 W, a carbamazepine solution (with a pH of 7) was mixed with a composite solution of PS and S(IV), the resulting mixed solution was subjected to a degradation at 20° C. for 40 min, resulting in a degradation rate of carbamazepine of 98.3%, wherein an initial concentration of CBZ ([CBZ]₀) was 21.16 μM (μM is μmol/L), both the initial concentrations of PS ([PS]₀) and S(IV) ([S(IV)]₀) were 0.3 mM (mM is mmol/L), and a molar ratio of PS to S(IV) to CBZ was 15:15:1, i.e., a molar ratio of PS to S(IV) was 1:1.

The concentration of CBZ was analyzed by high-performance liquid chromatography (HPLC), in which a mobile phase was a methanol-(0.1% acetic acid-water) solution with a volume ratio of methanol to 0.1% acetic acid-water of 6:4, a detection wavelength was 285 nm, a flow rate of the mobile phase was 0.8 mL/min, a single sample injection volume was 20 μL, and a retention time of CBZ was 5.5 min.

(2) Identification of Free Radicals

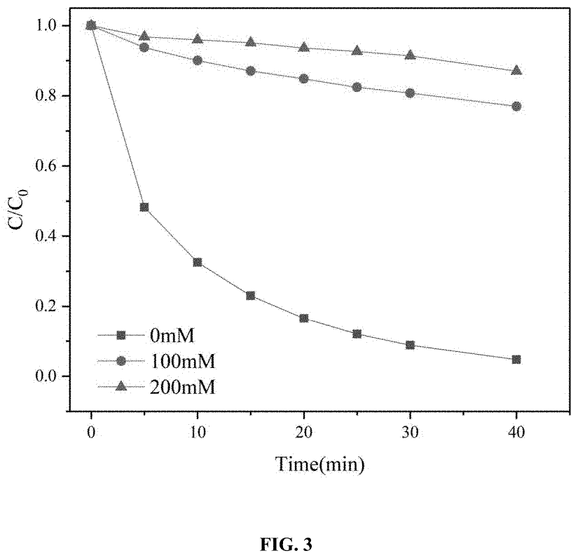

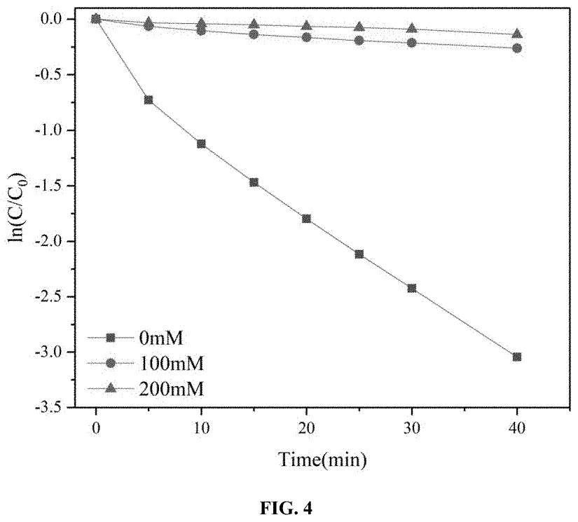

The results of the inhibition degree on active free radicals in the system obtained after degradation in step (1) without adding methanol, with adding 100 mM of methanol and with adding 200 mM of methanol are shown in FIG. 3. Reaction kinetics fittings were carried out for the process of the inhitition degree on active free radicals, and the results are shown in FIG. 4 and Table 1.

TABLE 1
Reaction kinetics equations and parameters for the degradation
of CBZ in the UV/PS/S(IV) system with adding methanol

| Amount of methanol | | | |
|---|---|---|---|
| added (mM) | Reaction kinetics equations | kobs (min⁻¹) | R² |
| 0 | In(Cₜ/C₀) = −0.1467x + 0.2245 | 0.1467 | 0.9768 |
| 100 | In(Cₜ/C₀) = −0.0062x − 0.0298 | 0.0062 | 0.9646 |
| 200 | In(Cₜ/C₀) = −0.0031x − 0.0062 | 0.0031 | 0.9669 |

It can be seen from FIGS. 3-4 and Table 1 that after adding 100 mM of methanol (MeOH), the degradation rates of CBZ after reacting for 5 min, 15 min and 40 min in the UV/PS/S(IV) system are decreased by 42%, 71% and 76%, respectively, and the reaction rate is also decreased from 0.1467 min⁻¹ under the condition of not adding MeOH to 0.0062 min⁻¹. Under the condition of adding 200 mM of MeOH, the overall situation is slightly lower than that under the condition of adding 100 mM of MeOH, and the reaction rate is decreased from 0.1467 min⁻¹ to 0.0031 min⁻¹, which is lower than that under the condition of adding 100 mM of MeOH. The degradation rates of CBZ after reacting for 5 min, 15 min and 40 min in the UV/PS/S(IV) system are decreased by 45%, 79% and 87%, respectively, indicating that the overall degradation rate is decreased to a greater degree. The above results show that the degradation of CBZ in water is mainly attributed to SO₄^{⋅-} and HO⋅.

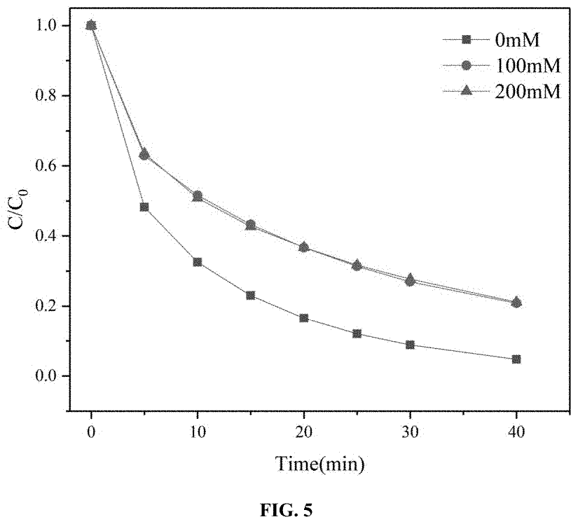

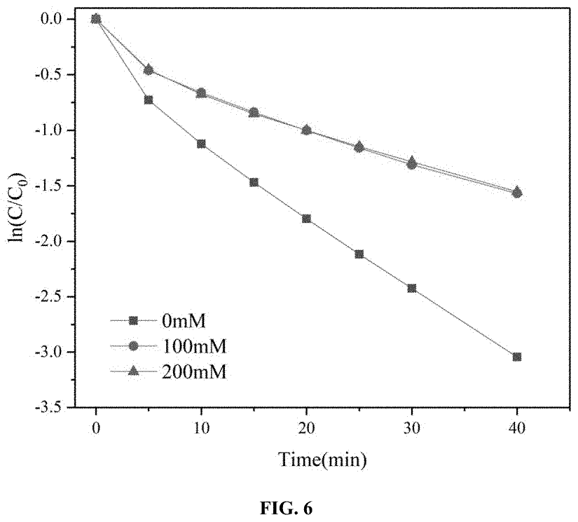

(3) To continue to study the specific types of the free radicals that degrade CBZ in the UV/PS/S(IV) system, 100 mM and 200 mM of tert-butanol (TBA) were used to replace MeOH in step (2) to study the inhibition degree on the active free radicals, and the results of the inhibition degree on the free radicals are shown in FIG. 5. Reaction kinetics fittings were carried out for the process of inhibition on the active free radicals, and the obtained results are shown in FIG. 6 and Table 2

TABLE 2
Reaction kinetics equations and parameters for the degradation
of CBZ in the UV/PS/S(IV) system with adding TBA

| Amount of TBA | | | |
|---|---|---|---|
| added (mM) | Reaction kinetics equations | kobs (min⁻¹) | R² |
| 0 | In(Cₜ/C₀) = −0.1467x + 0.2245 | 0.1467 | 0.9768 |
| 100 | In(Cₜ/C₀) = −0.0366x − 0.2116 | 0.0366 | 0.9552 |
| 200 | In(Cₜ/C₀) = −0.0360x − 0.2185 | 0.0360 | 0.9501 |

It can be seen from FIGS. 5-6 and Table 2 that after adding 100 mM of TBA, the degradation rates of CBZ after reacting for 5 min, 15 min and 40 min in the UV/PS/S(IV) system are decreased by 11%, 27% and 20%, respectively, and the reaction rate is decreased from 0.1467 min⁻¹ under the condition of not adding TBA to 0.0366 min⁻¹. Under the condition of adding 200 mM of TBA, the overall situation is almost unchanged compared with that under the condition of adding 100 mM of TBA, and the reaction rate is decreased from 0.1467 min⁻¹ to 0.0360 min⁻¹, basically equal to that under the condition of adding 100 mM of TBA. The degradation rates of CBZ after reacting for 5 min, 15 min and 40 min in the UV/PS/S(IV) system are decreased by 12%, 26% and 21%, respectively. The above results show that SO₄^{⋅-} in water has a greater degradation effect on CBZ than HO⋅, and SO₄^{⋅-} may be the main active free radical to degrade CBZ.

Under the condition of adding a high concentration of a quencher, it could be assumed that the active free radicals in water are completely quenched. For example, under the condition of adding MeOH in a molar concentration of more than 300 times of the oxidizer (i.e., PS/S(IV)), it could be assumed that SO₄^{⋅-} and HO⋅ in water are completely quenched by MeOH, and thus the degradation of pollutants in water is completely attributed to the effect of SO₅^{⋅-}. Under the condition of adding a high concentration of TBA, it could be assumed that HO⋅ in water is completely quenched, and thus the degradation of the pollutants in water is attributed to the combined effect of SO₄^{⋅-} and SO₅^{⋅-}. Therefore, the theoretical values of the contribution rates of SO₄^{⋅-}, SO₅^{⋅-} and HO⋅ to the degradation of CBZ could be calculated by the degradation rates of CBZ under different conditions. The results are shown in Table 3

TABLE 3
Identification results of free radicals in the degradation process of CBZ

| | | Degradation | Degradation | | | Sum of | |
|---|---|---|---|---|---|---|---|
| | | rate of | rate of | | | contribution | Contribution |
| Reaction | Degradation | CBZ with | CBZ with | Contribution | Contribution | rate of | rate |
| time | rate of | adding | adding | rate of | rate of | SO₄^{•-} and | of SO₅^{•-} |
| (min) | CBZ (%) | TBA (%) | MeOH (%) | SO₄^{•-} (%) | HO• (%) | HO• (%) | (%) |
| 5 | 48.1 | 36.5 | 3.3 | 69.0 | 24.3 | 93.3 | 6.7 |
| 15 | 83.2 | 57.4 | 4.9 | 63.1 | 31.0 | 94.1 | 5.9 |
| 40 | 99.8 | 78.9 | 13.0 | 66.0 | 21.0 | 87.0 | 13.0 |

It can be seen from the identification results of free radicals in Table 3 that the degradation rates of CBZ in the UV/PS/S(IV) system at different times under the condition of adding 200 mM of MeOH and TBA could be specifically summarized as the identification results of relative contribution rate of free radicals in Tables 3-4. The relative contribution rates of SO₄^{⋅-}, HO⋅ and SO₅^{⋅-} to the degradation of CBZ in the UV/PS/S(IV) system are 69.0%, 24.3% and 6.7% respectively after reacting for 5 min, and are 63.1%, 31.0% and 5.9% respectively after reacting for 15 min, and are 66.0%, 21.0% and 13.0% respectively after reacting for 40 min. It can be seen that in the reaction process, the relative contribution rate of SO₄^{⋅-} to degradation always keeps at 66-69%, making the main contribution to the degradation. Thus, SO₄^{⋅-} is the main free radical for the degradation. HO⋅ results in a degradation effect which is increased firstly and then decreased, and a relative contribution rate ranging from 21% to 31%, indicating that HO⋅ also makes a little contribution to the degradation. SO₅^{⋅-} results in a relative contribution rate ranging from 5.9% to 13.0%, indicating that it is not the main active free radical for the degradation.

### COMPARATIVE EXAMPLE 1

Using an UV/PS system to degrade carbamazepine in an apparatus shown in FIG. 1

Under the irradiation of ultraviolet lamp, a carbamazepine solution (with a pH of 7) was mixed with a persulfate solution, and the resulting mixed solution was subjected to a degradation at 20° C. for 40 min, resulting in a degradation rate of carmazepine of 88.3%, wherein an initial concentration of carbamazepine ([CBZ]₀) was 21.16 μM, and an initial concentration of persulfate ([PS]₀) was 0.3 mM, a molar ratio of persulfate to carbamazepine was 15:1.

### COMPARATIVE EXAMPLE 2

Using an UV/S(IV) system to degrade carbamazepine in an apparatus shown in FIG. 1

Under the irradiation of ultraviolet lamp, a carbamazepine solution (with a pH of 7) was mixed with a sulfite solution, and the resulting mixed solution was subjected to a degradation at 20° C. for 40 min, resulting in a degradation rate of carbamazepine of 28.9%, wherein an initial concentration of carbamazepine ([CBZ]₀) was 21.16 μM, an initial concentration of sulfite ([S(IV)]₀) was 0.3 mM, a molar ratio of sulfite to carbamazepine was 15:1.

### COMPARATIVE EXAMPLE 3

Using a PS/S(IV) system to degrade carbamazepine

A carbamazepine solution (with a pH of 7) was mixed with a composite solution of persulfate and sulfite, and the resulting mixed solution was subjected to a degradation at 20° C. for 40 min, resulting in a degradation rate of carbamazepine of 49.6%, wherein an initial concentration of carbamazepine ([CBZ]₀) was 21.16 μM, an initial concentration of persulfate ([PS]₀) was 0.3 mM, an initial concentration of sulfite ([S(IV)]₀) was 0.3 mM, and a molar ratio of persulfate to sulfite to carbamazepine was 15:15:1.

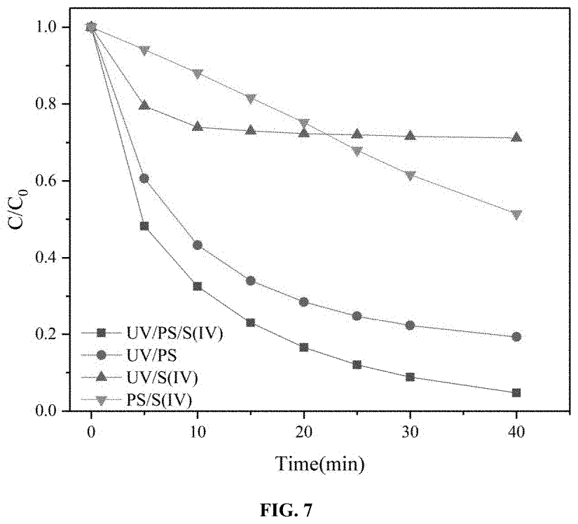

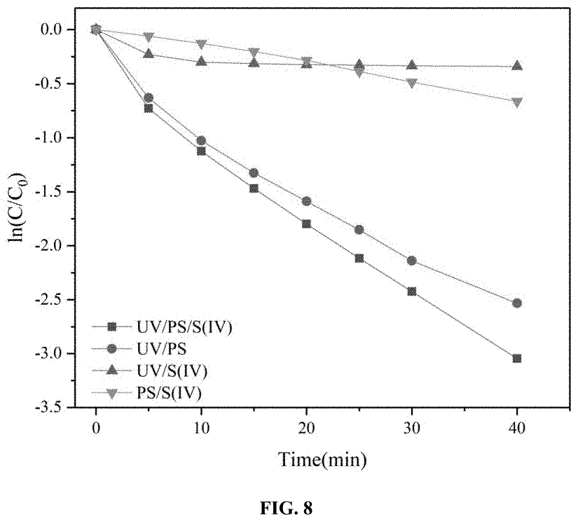

The degradation rates of carbamazepine in the different degradation systems in Example 1 and Compararive Examples 1-3 are shown in FIG. 7. Reaction kinetics fittings were carried out for the degradation process of CBZ, and the results are shown in FIG. 8 and Table 4. It can be seen from FIGS. 7-8 about the degradations of CBZ in different systems. By comparison, it can be seen that the UV/S(IV) and PS/S(IV) systems exhibit poor effects on the degradation of CBZ, and have degradation rates of 28.9% and 49.6 respectively after reacting for 40 min. The typical advanced oxidation system, i.e., the UV/PS system, has a degradation rate of CBZ of 88.2% after fully reacting for 40 min. The UV/PS/S(IV) system with a molar ratio of PS to S(IV) to CBZ of 15:15:1 results in a degradation rate of CBZ reaching 98.3% after reacting for 40 min, which is 10% higher than that of the UV/PS system, and 70% higher than that of the UV/S(IV) system, and 46% higher than that of the PS/S(IV) system. This result can be attributed to SO₄^{⋅-} and HO⋅ generated by Formulas (1) to (6).

TABLE 4
Reaction kinetics equations and parameters for the
degradations of CBZ in different systems

| System | Reaction kinetics equations | kobs (min⁻¹) | R² |
|---|---|---|---|
| UV/PS/S(IV) | In(Cₜ/C₀) = −0.0722x − 0.2791 | 0.0722 | 0.9798 |
| UV/PS | In(Cₜ/C₀) = −0.0607x − 0.2857 | 0.0607 | 0.9660 |
| PS/S(IV) | In(Cₜ/C₀) = −0.0169x + 0.0294 | 0.0169 | 0.9930 |
| UV/S(IV) | In(Cₜ/C₀) = −0.0063x − 0.1575 | 0.0063 | 0.5307 |

It can be seen from Table 4 that the UV/PS/S(IV), UV/PS, and PS/S(IV) systems are in consistent with the pseudo-first-order reaction kinetics; among them, the UV/PS/S(IV) system results in the fastest reaction rate.

Compared with the method described in the literature of “Study on UV-activated persulfate oxidation of carbamazepine in water” (Gao Naiyun, Hu Xuhao, Deng Jing, Chen Yichun, Journal of Huazhong University of Science and Technology (Natural Science Edition), 2013, 41(12):117-122), under the conditions of the same carbamazepine concentration and temperature, and similar persulfate concentration, the degradation rate is increased from 0.027 min⁻¹ to 0.0722 min⁻¹, with an increase rate of 167.4%, which greatly shortens the degradation time of carbamazepine.

### EXAMPLE 2

CBZ was degraded according to the method of Example 1, except that the initial concentration of PS was 0.3 mM, and the ratio of the initial molar concentration of PS to S(IV) was 1:1.

### EXAMPLE 3

CBZ was degraded according to the method of Example 1, except that the initial concentration of S(IV) was 0.6 mM, and the ratio of the initial molar concentration of PS to S(IV) was 1:2.

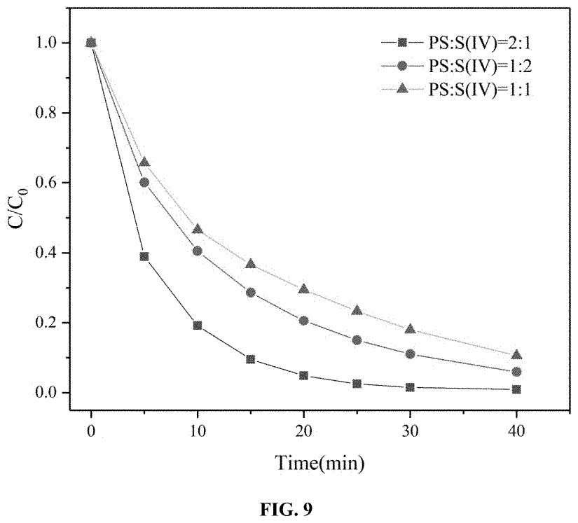

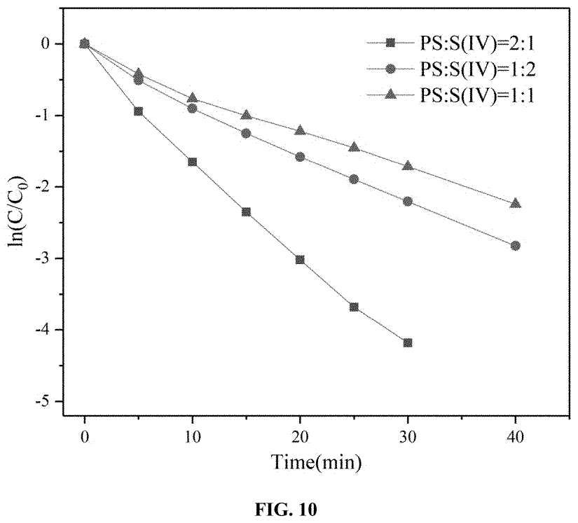

The results about the degradation rates of CBZ in Examples 1-3 are shown in FIG. 9. Reaction kinetics fittings were carried out for the degradation process of CBZ, and the obtained results are shown in FIG. 10 and Table 5.

TABLE 5
Reaction kinetics equations and parameters for the degradation
of CBZ in the UV/PS/S(IV) system with different molar ratios of PS to S(IV)

| Molar ratio of PS to | | | |
|---|---|---|---|
| S(IV) | Reaction kinetics equations | kobs (min⁻¹) | R² |
| 2:1 | In(Cₜ/C₀) = −0.1386x − 0.1837 | 0.1386 | 0.9938 |
| 1:2 | In(Cₜ/C₀) = −0.0690x − 0.1452 | 0.0690 | 0.9931 |
| 1:1 | In(Cₜ/C₀) = −0.0536x − 0.1306 | 0.0536 | 0.9906 |

It can be seen from FIG. 9 that under the condition that the initial concentration of PS is kept at 0.3 mM and the initial concentration of S(IV) is increased from 0.3 mM to 0.6 mM, the degradation rate of CBZ tends to be increased, and is increased from 89.4% to 94.1% after reacting for 40 min. That may be due to the fact that S(IV) with high concentration could generate more sulfate radical, which is beneficial to the oxidation of CBZ, thereby enhancing the degradation of target pollutants. Under the conditions that the initial concentration of S(IV) is kept at 0.3 mM and the initial concentration of PS is increased from 0.3 mM to 0.6 mM, the degradation rate of CBZ is increased from 89.4% to 98.1%, showing an increasing tend. This may mean that as the initial concentration of PS increases, more reactive matters will be produced, resulting in a faster degradation efficiency of CBZ by PS. However, an excessive amount of oxidizer may inhibit the degradation, because the excessive amount of oxidizer may quench hydroxyl radicals and sulfate radicals. However, there is no inhibition effect caused by oxidizers in the method of the present disclosure, because the amount of oxidizers does not reach the excessive standard for quenching the active free radicals.

It can be seen from FIG. 10 and Table 5 that the results about the degradation of CBZ with different ratios of the molar concentration (i.e molar ratio) of PS to S(IV) are in consistent with the pseudo-first-order reaction kinetics. The reaction rate K_{obs} at the ratio of the molar concentration (i.e molar ratio) of PS to S(IV) of 2:1 is the fastest, but the final degradation rate at this ratio is only 9% higher than that at the ratio of 1:1. Therefore, considering the cost, the subsequent experiments were conducted at the ratio of 1:1.

### EXAMPLE 4

CBZ was dissolved in a 30% acetonitrile aqueous solution, obtaining a CBZ stock solution with a concentration of 211.6 μM. 25 mL of the CBZ stock solution was taken and diluted to a volume of 500 mL with ultrapure water, obtaining a CBZ solution with a concentration of 10.08 μM. The CBZ solution was poured into a beaker, and 3 mL of an aqueous PS solution with a concentration of 0.3 mM and 3 mL of an aqueous S(IV) solution with a concentration of 0.3 mM were added into the beaker. The resulting mixed solution was subjected to a degradation for 40 min.

### EXAMPLE 5

CBZ was degraded according to the method of Example 4, except that 50 mL of the CBZ stock solution was taken and diluted to a volume of 500 mL with ultrapure water, obtaining a CBZ solution with a concentration of 21.16 μM.

### EXAMPLE 6

CBZ was degraded according to the method of Example 4, except that 100 mL of the CBZ stock solution was taken and diluted to a volume of 500 mL with ultrapure water, obtaining a CBZ solution with a concentration of 42.36 μM.

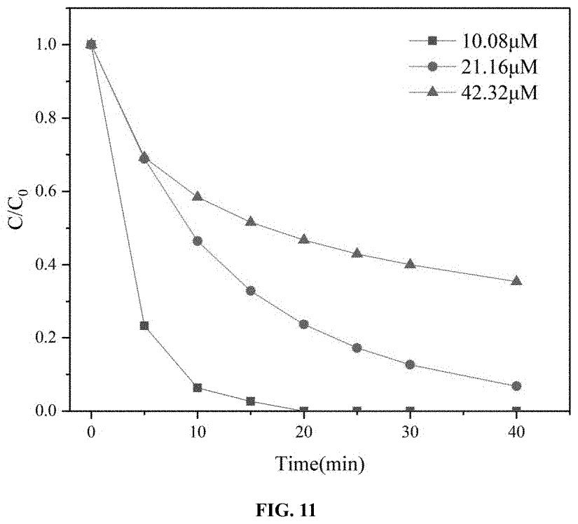

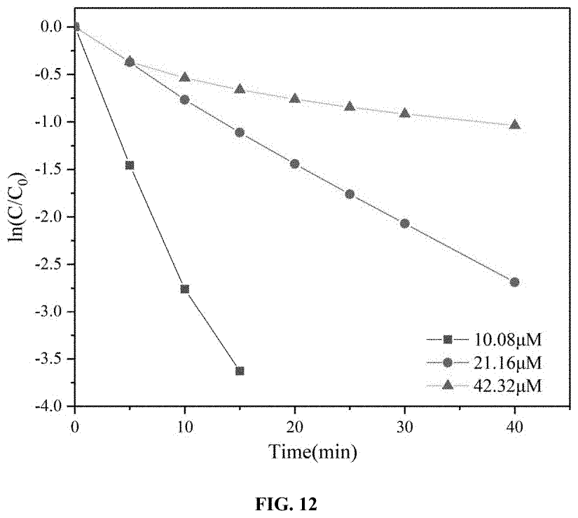

The concentrations of CBZ in the systems after degradation in Examples 4-6 were tested at regular intervals. The results about the degradation rates of CBZ are shown in FIG. 11. Reaction kinetics fittings were carried out for the degradation process of CBZ, and the obtained results are shown in FIG. 12 and Table 6.

TABLE 6
Reaction kinetics equations and parameters for the degradation
of CBZ in the UV/PS/S(IV) systems with
different initial concentrations of CBZ

| Initial | | | |
|---|---|---|---|
| concentration of | | | |
| CBZ (MM) | Reaction kinetics equations | kobs (min⁻¹) | R² |
| 10.08 | In(Cₜ/C₀) = −0.2438x − 0.1331 | 0.2438 | 0.9938 |
| 21.16 | In(Cₜ/C₀) = −0.0670x − 0.0613 | 0.0670 | 0.9977 |
| 42.32 | In(Cₜ/C₀) = −0.0237x − 0.2110 | 0.0237 | 0.9316 |

It can be seen from FIG. 11 that as the initial concentration of CBZ increases, the degradation rate of the target pollutants in the UV/PS/S(IV) system is significantly decreased. Under the condition that the concentration of CBZ reaches 10.08 μM, and the molar ratio of CBZ to PS to S(IV) is 1:30:30, CBZ is completely degraded after fully reacting for 20 min. Under the condition that the concentration of CBZ reaches 42.32 μM, and the molar ratio of CBZ to PS to S(IV) is 1:7.5:7.5, the degradation rate of CBZ is only 65.5% after fully reacting for 40 min, which is reduced by 31% compared with 95.3% as the degradation rate under the condition that the concentration of CBZ is 21.16 μM. That may be attributed to the fact that under the same conditions of the UV light intensity and the amounts of PS and S(IV) added, the number of the free radicals for degrading the pollutants in the system are also the same; however, under the condition that the concentration of the pollutants is increased, the concentration of organic pollutants in the unit volume of the solution is also increased, and correspondingly, the relative amount of the free radicals contacted with the organic pollutants is decreased, leading to a decrease in the steady-state concentration of the free radicals in the system, which is unfavorable for the degradation of pollutants. On the other hand, the residual pollutants caused by excessive CBZ will compete the active free radicals in the solution with the intermediate products generated in the degradation process, which ultimately results in a decrease of the degradation rate of CBZ.

It can be seen from FIG. 12 and Table 6 that In(C/C₀) has a good linear relationship with t, and conforms to the pseudo-first-order reaction kinetics. The reaction rate is decreased with the increase of the initial concentration of CBZ, and the reaction rate and the initial concentration of CBZ are generally negatively correlated. Under the condition that the concentration of the CBZ is doubled, the degradation rate in the system is slowed for 3-4 times.

### EXAMPLE 7

CBZ was degraded according to the method of Example 1, except that 0.25 mM of CO₃²⁻ was added to the system before the degradation.

### EXAMPLE 8

CBZ was degraded according to the method of Example 1, except that 0.5 mM of CO₃²⁻ was added to the system before the degradation.

### EXAMPLE 9

CBZ was degraded according to the method of Example 1, except that 1 mM of CO₃²⁻ was added to the system before the degradation.

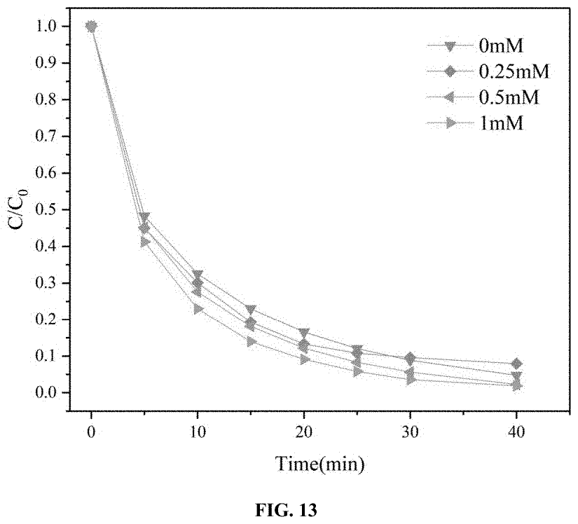

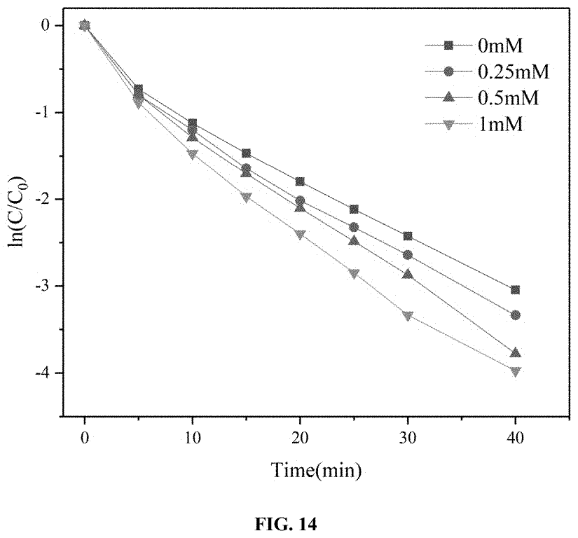

The concentration of CBZ in the systems after degradation of Examples 1, and 7-9 were tested at regular intervals. The results about the degradation rates of CBZ are shown in FIG. 13. Reaction kinetics fitting were carried out for the degradation process of CBZ, and the obtained results are shown in FIG. 14 and Table 7.

TABLE 7
Reaction kinetics equations and parameters for the degradation
of CBZ in the UV/PS/S(IV) system with
different initial concentrations of CO₃²⁻

| CO₃²⁻ (mM) | Reaction kinetics equations | kobs (min⁻¹) | R² |
|---|---|---|---|
| 0 | In(Cₜ/C₀) = −0.0722t − 0.2791 | 0.0722 | 0.9798 |
| 0.25 | In(Cₜ/C₀) = −0.0792t − 0.3095 | 0.0792 | 0.9783 |
| 0.5 | In(Cₜ/C₀) = −0.0894t − 0.2572 | 0.0894 | 0.9885 |
| 1 | In(Cₜ/C₀) = −0.0969t − 0.3530 | 0.0969 | 0.9781 |

It can be seen from FIG. 13 that under the condition that the concentration of CO₃²⁻ in the UV/PS/S(IV) system ranges from 0 mM to 1 mM, the overall degradation effect of CBZ is promoted. Among others, under the condition that the concentration of CO₃²⁻ is 1 mM, the degradation rate of CBZ is 3% higher than that without CO₃²⁻. However, this result is different from the influence to degradation of CBZ in the presence of CO₃²⁻ when using the UV/PS system alone. The reason is speculated that CO₃²⁻ has two nucleophilic atoms O⁻, which could attack the O—O bond to activate PS to produce more SO₄^{⋅-}, significantly increasing the degradation rate. In addition, CO₃²⁻ in water undergoes the reaction according to Formula (7), which makes the water alkaline, while the presence of S(IV) makes the degradation rate of CBZ in the UV/PS/S(IV) system increased in the alkaline water.

CO₃²⁻+H₂O→HCO₃⁻+OH⁻ Formula (7)

The concentration of CO₃²⁻ has inhibition effect on the photodegradant, the reaction mechanism of which is shown in Formulas (8) to (9). It can be seen from the experimental results that the inhibition effect is weaker than the promotion effect, and the degradation rate is generally increased with the increase of the concentration of CO₃²⁻. However, excessive CO₃²⁻ could also quench SO₄^{⋅-} and HO⋅, and consume a large amount of the free radicals with strong oxidizability to generate CO₃²⁻ resulting in a decrease of the degradation rate. While the concentration of CO₃²⁻ used in the present disclosure does not reach the excessive standard.

CO₃²⁻+SO₄^{⋅-}→SO₄²⁻+CO₃^{⋅-} Formula (8)

CO₃²⁻+HO⋅→CO₃^{⋅-}+OH⁻ Formula (9)

It can be seen from FIG. 14 and Table 7 that the degradation process of CBZ in the UV/PS/S(IV) system strictly follows the pseudo-first-order kinetics equation. Under the condition that a concentration of CO₃²⁻ was 1 mM, the reaction rate is fastest, and K_{obs} is 0.0969 min⁻¹, which is increased by 25.5% compared with that without adding CO₃²⁻.

### EXAMPLE 10

CBZ was degraded according to the method of Example 1, except that the pH value of the CBZ solution was 3.

### EXAMPLE 11

CBZ was degraded according to the method of Example 1, except that the pH value of the CBZ solution was 5.

### EXAMPLE 12

CBZ was degraded according to the method of Example 1, except that the pH value of the CBZ solution was 9.

### EXAMPLE 13

CBZ was degraded according to the method of Example 1, except that the pH value of the CBZ solution was 11.

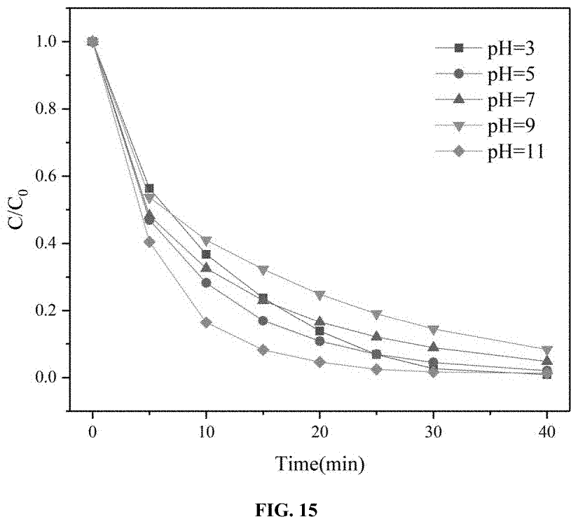

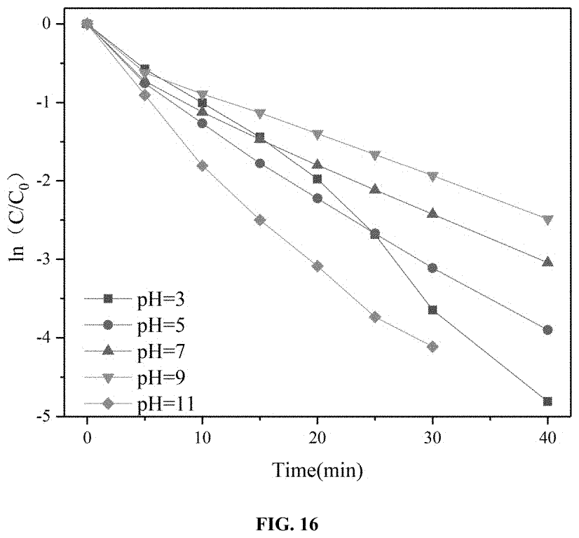

The concentration of CBZ in systems after degradation of Examples 1, and 10-13 were tested at regular intervals. The results about the degradation rates of CBZ were shown in FIG. 15. Reaction kinetics fittings were carried out for the degradation process of CBZ, and the obtained results are shown in FIG. 16 and Table 8.

TABLE 8
Reaction kinetics equations and parameters for the
degradations of CBZ in the UV/PS/S(IV)
systems with different initial pH values

| pH | Reaction kinetics equations | Kobs (min⁻¹) | R² |
|---|---|---|---|
| 3.0 | In(Cₜ/C₀) = −0.1207x + 0.1710 | 0.1207 | 0.9865 |
| 5.0 | In(Cₜ/C₀) = −0.0955x − 0.2323 | 0.0955 | 0.9907 |
| 7.0 | In(Cₜ/C₀) = −0.0722x − 0.2791 | 0.0722 | 0.9798 |
| 9.0 | In(Cₜ/C₀) = −0.0581x − 0.2117 | 0.0581 | 0.9826 |
| 11.0 | In(Cₜ/C₀) = −0.1377x − 0.2412 | 0.1377 | 0.9844 |

It can be seen from FIGS. 15-16 and Table 8 that the degradation rates of CBZ under the acidic and neutral conditions are higher than that under the weakly alkaline condition, while the degradation rate of CBZ under the strongly alkaline condition is significantly increased. After reacting for 40 min, all the degradation rates of CBZ in the UV/PS/S(IV) system with different initial pH values could exceed 92%. Under the condition that the pH value is 11, the best degradation effect on CBZ is obtained, and the maximum degradation rate K_{obs} of CBZ is 0.1377 min⁻¹.

In the UV/PS/S(IV) system, the experimental data shows a good linear fitting degree, and the degradation processes of CBZ with different initial pH values are in consistent with the pseudo-first-order reaction kinetics equation, and the reaction rate K_{obs} gradually decreases according to the order of the pH values of 11, 3, 5, 7 and 9.

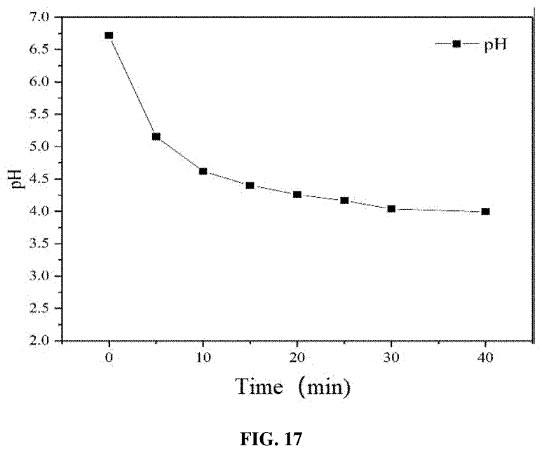

The change of the pH value of the solution during the degradation process of CBZ in the UV/PS/S(IV) system of Example 1 is shown in FIG. 17. It can be seen from FIG. 17 that the pH value of the solution before and after degrading CBZ in the UV/PS/S(IV) system is decreased from 7.002 to 4.037, which fully demonstrates the presence of Formula (8). The decrease of HO⁻ in the solution results in the decrease of the pH value.

The above results show that the UV/PS/S(IV) system has a wide applicable pH range for the degradation of CBZ, which effectively solves the problem of low efficiency of the UV/PS system on degradation of the pollutants in alkaline environments, and could be used to efficiently degrade the organic pollutants in strong alkaline environments.

The above description is only preferred embodiments of the present disclosure. It should be pointed out that several improvements and modifications still could be made by those ordinarily skilled in the art without deviating from the principle of the present disclosure, which shall fall within the protection scope of the present disclosure.

1. A photodegradant of carbamazepine, comprising a composite solution of a persulfate and a sulfite.

2. The photodegradant of claim 1, wherein a molar ratio of the persulfate to the sulfite in the composite solution is in the range of (1-2):(1-2).

3. A method for degrading carbamazepine by using the photodegradant of claim 1, comprising the following steps:
mixing a carbamazepine solution with the composite solution of the persulfate and the sulfite under ultraviolet irradiation to obtain a mixed solution, and subjecting the mixed solution to a degradation.

4. The method of claim 3, wherein a molar ratio of carbamazepine in the carbamazepine solution to the persulfate to the sulfite is in the range of 1:(15-20):(15-20).

5. The method of claim 3, wherein the carbamazepine solution has a concentration of 5-50 mmol/L.

6. The method of claim 3, wherein the carbamazepine solution has a pH value of 3-11.

7. The method of claim 3, wherein the degradation is conducted for 20-50 min.

8. An apparatus used for the method according to claim 3, comprising a reaction vessel (3), a quartz sleeve (2) arranged inside the reaction vessel (3), and an ultraviolet light source (1) arranged inside the quartz sleeve (2).

9. The method of claim 5, wherein the carbamazepine solution has a pH value of 3-11.

10. The method of claim 4, wherein the degradation is conducted for 20-50 min.
